(19) United States
(12) Patent Application Publication
(10) Pub. No.: US 2014/0006128 A1
(43) Pub. Date: Jan. 2, 2014

(54) SYSTEMS AND METHODS FOR PRESENTING OFFERS DURING A SHOPPING EXPERIENCE

(71) Applicants: David M. Grigg, Rock Hill, SC (US); Alicia C. Jones, Fort Mill, SC (US); Matthew A. Calman, Charlotte, NC (US); Susan Smith Thomas, Gastonia, NC (US)

(72) Inventors: David M. Grigg, Rock Hill, SC (US); Alicia C. Jones, Fort Mill, SC (US); Matthew A. Calman, Charlotte, NC (US); Susan Smith Thomas, Gastonia, NC (US)

(73) Assignee: BANK OF AMERICA CORPORATION, Charlotte, NC (US)

(21) Appl. No.: 13/536,806

(22) Filed: Jun. 28, 2012

(51) Int. Cl. G06Q 30/02

(52) U.S. Cl. 705/14.23; 705/14.49

(57) ABSTRACT

Embodiments of the invention are directed to systems, methods, and computer program products for presenting one or more offers to a user during an online shopping experience including the steps of receiving an input that the user has initiated the online shopping experience, receiving one or more product identifiers, comparing the one or more product identifiers to at least one rule, determining the one or more offers for one or more products associated with the one or more product identifiers, presenting to the user, via a user interface, the offer for the product before the consumer enters the point of transaction area of the store, receiving an input from the user accepting the one or more offers; and transmitting acceptance of the one or more offers by the user to at least one of a financial institution of the user or the merchant.

### FIELD

In general, embodiments of the invention relate to systems, methods, and computer program products for presenting offers for products to a consumer during a shopping experience.

### BACKGROUND

The following U.S. patent application is filed concurrently with the present application and is hereby incorporated by reference: U.S. patent application Ser. No. ______ to Grigg et al. and entitled “Systems and Methods for Presenting Offers During An In-Store Shopping Experience.”

Consumers typically have a variety of choices when selecting a product during a shopping experience. For example, if the consumer is selecting a box of cereal at a retail store, the retail store most likely has a multitude of cereal selections for the consumer to choose from. The consumer may select a particular cereal brand that she has historically selected during a prior shopping experience when she selected a box of cereal, without giving serious consideration to other cereal choices available.

Many factors may play a part in a consumer's selection of a particular brand of a product. The individual's perception of the brand, past use of the product of that brand, advertisement of the brand, offers for discounts for the brand, attributes such as convenience of the brand, etc., may all have a direct correlation with which brand of product an individual may select to purchase.

Present day, modern handheld mobile devices, such as smart phones or the like, have the capability to facilitate payment for a product or provide a token for boarding a train or flight. These advances combine multiple technologies through a handheld mobile device to provide a user with an array of capabilities. For example, many smart phones are equipped with significant processing power, sophisticated multi-tasking operating systems, and high bandwidth Internet connection capabilities. Moreover, such mobile devices often have additional features that are becoming increasingly more common and standardized features. Such features include, but are not limited to, location-determining devices, such a Global Positioning System (GPS) device; sensor devices, such as accelerometers; and high-resolution video cameras.

Even with these advances in technology, the factors that determine an individual's selection of one brand of product over another brand typically involves no technological factors. Further, a consumer may not know the qualities of products other than the products she has previously purchased or products having promotions. These promotions may include restrictions that limit the benefits at different times, on different products, or at different merchants, etc. Thus, there is a need to provide consumers with offers and promotions during a shopping experience useable on the relevant products that the consumer selects or would normally select based on various factors.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is present later.

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is present later.

Embodiments of the invention are directed to systems, methods, and computer program products for presenting offers, promotions, or payment suggestions to a consumer during an online shopping experience before an in-store pick up of at least one of the one or more products selected by the consumer for purchase from a merchant. For example, in one embodiment, a system is provided for presenting offers for user-selected products. In one embodiment, the system comprises: (1) a database comprising at least one rule, wherein the at least one rule relates to offers for one or more products; (2) a computerized apparatus associated with a consumer, where the computerized apparatus comprises a user interface; (3) a processing device in communication with the database and the mobile device; (4) a non-transitory computer readable medium comprising computer executable code, that when executed causes the processing device to: (a) receive input that the consumer has initiated an online an online shopping experience; (b) receive one or more product identifiers; (c) compare the one or more product identifiers to the at least one rule; (d) determine the one or more offers for one or more products associated with the one or more product identifiers based at least partially on the comparison of the one or more product identifiers to the at least one rule; (e) present to the consumer, via the user interface, the one or more offers before the consumer initiates the purchase of the one or more products at an online point of transaction; (f) receive input from the consumer accepting the one or more offers; and (g) transmit acceptance of the one or more offers by the consumer to at least one of a financial institution of the consumer or the merchant.

In one embodiment of the system, the system provides, via the user interface, a selectable button comprising an invitation to the user to apply the one or more offers presented for the one or more products, wherein the selectable button is configured to apply the one or more offers to the one or more products when selected by the user.

In one embodiment of the system, the system reviews a virtual or a physical shopping cart comprising the one or more products selected by the consumer and make suggestions for one or more offers based on the one or more products in the virtual or the physical shopping cart.

In one embodiment of the system, the system displays, via the user interface, the aggregate benefit provided by the one or more offers for the one or more products selected by the consumer, where the aggregate benefit comprises, at least, a total dollar savings amount or total points earned for purchasing the one or more products.

In one embodiment of the system, the system determines a dynamic offer based at least partially on a combination of two or more offers previously presented to the user.

In one embodiment of the system, the system provides, at the point of transaction area, verification to the consumer that the one or more offers will successfully be applied to a transaction based at least partially on the one or more products being presented for purchase at the point of transaction area.

In one embodiment of the system, the at least one rule relates at least partially to presenting offers for discounts, coupons, loyalty points, or payment suggestions for the product associated with the product identifier.

In one embodiment of the system, the system (a) determines a first virtual or online shopping cart, wherein the first virtual online shopping cart comprises the one or more products selected by the user, (b) determines a second virtual or online shopping cart based at least partially on the first virtual or online shopping cart, wherein the contents of the second virtual or online shopping cart is different from the first virtual or online shopping cart; and (c) displays, via the user interface, a comparison of the first virtual or online shopping cart to the second virtual or online shopping cart.

As another example, in another embodiment of the invention, a computer implemented method is provided for presenting offers, promotions, or payment suggestions to a consumer during a shopping experience in a store of a merchant. In one embodiment, the method comprises: providing a computer processor executing computer readable code structured to cause the computer processor to: (a) receive input that the consumer has initiated an online an online shopping experience; (b) receive one or more product identifiers; (c) compare the one or more product identifiers to the at least one rule; (d) determine the one or more offers for one or more products associated with the one or more product identifiers based at least partially on the comparison of the one or more product identifiers to the at least one rule; (e) present to the consumer, via the user interface, the one or more offers before the consumer initiates the purchase of the one or more products at an online point of transaction; (f) receive input from the consumer accepting the one or more offers; and (g) transmit acceptance of the one or more offers by the consumer to at least one of a financial institution of the consumer or the merchant.

In one embodiment of the computer implemented method, the method provides, via the user interface, a selectable button comprising an invitation to the user to apply the one or more offers presented for the one or more products, wherein the selectable button is configured to apply the one or more offers to the one or more products when selected by the user.

In one embodiment of the computer implemented method, the method reviews a virtual or a physical shopping cart comprising the one or more products selected by the consumer and make suggestions for one or more offers based on the one or more products in the virtual or the physical shopping cart.

In one embodiment of the computer implemented method, the method displays, via the user interface, the aggregate benefit provided by the one or more offers for the one or more products selected by the consumer, where the aggregate benefit comprises, at least, a total dollar savings amount or total points earned for purchasing the one or more products.

In one embodiment of the computer implemented method, the method determines a dynamic offer based at least partially on a combination of two or more offers previously presented to the user.

In one embodiment of the computer implemented method, the computer processor receives input that the user has entered the store from the mobile device, automatically and independent of an indication by the user.

In one embodiment of the computer implemented method, the method (a) determines a first virtual or online shopping cart, wherein the first virtual online shopping cart comprises the one or more products selected by the user, (b) determines a second virtual or online shopping cart based at least partially on the first virtual or online shopping cart, wherein the contents of the second virtual or online shopping cart is different from the first virtual or online shopping cart; and (c) displays, via the user interface, a comparison of the first virtual or online shopping cart to the second virtual or online shopping cart.

As another example, in another embodiment of the invention, a computer program product is provided for presenting offers, promotions, or payment suggestions to a consumer during a shopping experience in a store of a merchant. In one embodiment, the computer program product comprises: a non-transitory computer readable medium comprising a set of codes for causing a computer to: (a) receive input that the consumer has initiated an online an online shopping experience; (b) receive one or more product identifiers; (c) compare the one or more product identifiers to the at least one rule; (d) determine the one or more offers for one or more products associated with the one or more product identifiers based at least partially on the comparison of the one or more product identifiers to the at least one rule; (e) present to the consumer, via the user interface, the one or more offers before the consumer initiates the purchase of the one or more products at an online point of transaction; (f) receive input from the consumer accepting the one or more offers; and (g) transmit acceptance of the one or more offers by the consumer to at least one of a financial institution of the consumer or the merchant.

In one embodiment of the computer program product, the computer program product uses a set of codes to provide, via the user interface, a selectable button comprising an invitation to the user to apply the one or more offers presented for the one or more products, wherein the selectable button is configured to apply the one or more offers to the one or more products when selected by the user.

In one embodiment of the computer program product, the computer program product uses a set of codes to review a virtual or a physical shopping cart comprising the one or more products selected by the consumer and make suggestions for one or more offers based on the one or more products in the virtual or the physical shopping cart.

In one embodiment of the computer program product, the computer program product uses a set of codes to display, via the user interface, the aggregate benefit provided by the one or more offers for the one or more products selected by the consumer, where the aggregate benefit comprises, at least, a total dollar savings amount or total points earned for purchasing the one or more products.

In one embodiment of the computer program product, the computer program product uses a set of codes to determine a dynamic offer based at least partially on a combination of two or more offers previously presented to the user.

### BRIEF DESCRIPTION OF THE DRAWINGS

Having thus described embodiments of the invention in general terms, reference will now be made to the accompanying drawings, where:

FIG. 1 is a flowchart illustrating a general process flow 100 for presenting an offer during an online shopping experience, in accordance with embodiments of the invention;

FIG. 2 is a block diagram illustrating the technical components of a system 200 for presenting an offer during an online experience, in accordance with embodiments of the invention;

FIG. 3 is a block diagram illustrating the technical components of a mobile device 300 for presenting an offer during an online shopping experience, in accordance with embodiments of the invention;

FIG. 4 is a block diagram illustrating a layout of an environment for an in-store shopping experience, in accordance with embodiments of the invention; and

FIG. 5 is a block diagram illustrating a point of transaction system, in accordance with embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the invention may take the form of a computer program product having a computer-readable storage medium having computer-executable program code embodied in the medium.

Any suitable computer-readable medium may be utilized. The computer-readable medium may be, for example but not limited to, an electronic, magnetic, optical, electromagnetic, infrared, or semiconductor system, apparatus, or device. For example, in one embodiment, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or other tangible optical or magnetic storage device.

Computer-executable program code for carrying out operations of the invention may be written in object oriented, scripted and/or unscripted programming languages such as Java, Perl, Smalltalk, C++, SAS, SQL, or the like. However, the computer-executable program code portions for carrying out operations of the invention may also be written in conventional procedural programming languages, such as the “C” programming language or similar programming languages.

Some embodiments of the invention are described herein with reference to flowchart illustrations and/or block diagrams of apparatus and/or methods. Each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The computer-executable program code may also be loaded onto a computer or other programmable data processing apparatus to cause a series of operational steps to be performed on the computer or other programmable apparatus to produce a computer-implemented process such that the computer-executable program code which executes on the computer or other programmable apparatus provides steps for implementing the functions/acts specified in the flowchart and/or block diagram block(s). Alternatively, computer-implemented steps or acts may be combined with operator or human implemented steps or acts in order to carry out an embodiment of the invention.

Although many of the embodiments of the invention described herein are generally described as involving “a business merchant,” one of ordinary skill in the art will appreciate that other embodiments of the invention may involve a bank or other financial institutions or businesses that take the place of, or work in conjunction with, the business merchant to perform one or more of the processes or events described herein.

The term “business merchant,” as used herein, refers to any person, association, machine, apparatus, and/or any other thing capable of selling, offering for sale, distributing, trading, and/or otherwise dealing in one or more goods and/or services. In some embodiments, the business merchant(s) actually produce and/or provide the goods and/or services being sold, while in other embodiments, the business merchant(s) distribute the goods and/or services but do not produce and/or provide the goods and/or services. In one embodiment described herein, the business merchant is a grocer that offers one or more retail grocery products to a consumer.

The term “product,” as used herein, refers to any good and/or service capable of being sold, offered for sale, distributed, traded, and/or otherwise dealt by a business merchant.

In some embodiments, the “user” may be a consumer or a customer (e.g., an account holder or a person who has an account (e.g., banking account, credit account, etc.) at the entity or otherwise has performed business with the entity) or potential customer (e.g., a person who has submitted an application for an account).

The term “consumer,” as described in many of the embodiments herein, refers to any person, association, machine, apparatus, and/or anything capable of buying, using, consuming, and/or acquiring one or more products from a business merchant. In some embodiments, a consumer may be a business merchant and/or vice versa. In other embodiments, a consumer may be a customer of a bank or some other financial institution.

In still further embodiments, a transaction may refer to an event and/or action or group of actions facilitated or performed by a user's device, such as a user's mobile computing device, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant's system, and in yet other embodiments, it refers to both a user device and a merchant device interacting to perform a transaction. For example, in one embodiment, in one embodiment, the POT system refers to the user's mobile device configured to communicate with a merchant's system, whereas in other embodiments, the POT system refers to a merchant's system configured to communicate with a user's personal computing device, and in yet other embodiments, the POT system refers to both the user's personal computing device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with a business merchant or some entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo WHO, PlayStation Portable®, etc.), and/or various combinations of the foregoing.

In some embodiments, a POT system is operated in a public place (e.g., on a street corner, at the doorstep of a private residence, in an open market, at a public rest stop, etc.). In other embodiments, the POT system, is additionally or alternatively operated in a place of business (e.g., in a retail store, post office, banking center, grocery store, factory floor, etc.). In accordance with some embodiments, the POT system is not owned by the user of the POT system. Rather, in some embodiments, the POT system is owned by a mobile business operator or a POT operator (e.g., merchant, vendor, salesperson, etc.). In yet other embodiments, the POT system is owned by the financial institution offering the POT system providing functionality in accordance with embodiments of the invention described herein.

In some embodiments, an area or physical location within the store of a business merchant capable of using a POT system to perform transactions may be referred to herein as a “point-of-transaction area” or “POT area.” A POT area may refer to any location within the store of the business merchant where a user may use to perform a transaction, for example, once a user has selected one or more products from within a store of a business merchant for purchase, the user may go to the POT area of the store of the business merchant to pay for the purchase of the one or more products. A POT area may be designated by signage or some visual display indicating an area of the store of the business merchant for performing a purchase transaction of the one or more products selected by a user.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the financial institution may allow a user to establish an account with the financial institution. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the financial institution.

In general terms, embodiments of the invention are directed to systems, methods, and computer program products for presenting offers to a user, and more particularly, for presenting offers for products to users during a shopping experience in a store of a business merchant prior to the user entering a point of transaction area of the store. For example, it is well known that some users that shop prefer to save money and potentially earn benefits by purchasing products. In most cases, these type of users receive newspapers, store flyers, or the like that either have coupons for use by the user or notifies the user of on sale products. Thus, in these cases, in order to redeem the coupon or other benefit, the user must usually present the coupons or flyer to the associated business merchant prior to the expiration of the coupon or benefit associated with the flyer. In some embodiments of the invention, the system is configured to receive product identifying input from the user using a mobile device and thereafter present to the user at least one offer, coupon, discount, loyalty points, or payment suggestion for a product associated with the product identifying information before the user enters the point of transaction area of the store. Thus, the user is presented with timely and relevant offers that are useable during the user's shopping experience. In some embodiments, the offers are meant to persuade the user to switch from using certain payment accounts or products to using one or more payment vehicles preferred by the merchant and/or user's financial institution.

To meet these objectives, according to one embodiment of the invention, a user may utilize any mobile computing device to capture or scan product identifying information and subsequently be presented with an offer for a product associated with the product identifying information directly on the mobile device of the user. In another embodiment, the user may select or input a product identifier on an online user interface associated with a computing device and subsequently is presented with an offer for a product associated with the product identifying information in the online user interface before an in-store pick up of the product.

Of course, other embodiments of the invention may vary from the examples described above without departing from the scope and spirit of the invention. For example, in some embodiments the user's shopping experience is out-of-store, for example, at the user's home, place of work, school, remote kiosk and/or the like. In those instances, the user is shopping and/or browsing using an online user interface or some mobile computing device having an online user interface. In such cases, the products or items of interest to the user appear on or are being presented by the online user interface where the user is able to select an item for purchase or inspection. In those embodiments, once the buyer selects a product or product identifier in the online user interface, the system of the invention determines one or more offers for the one or more products selected by the user. In another example, an embodiment of the invention may be configured to present an online banking customer with an offer during a shopping experience using the online banking account. For example, the user begins an online banking session by logging in and being authenticated by the system, and using online banking account the user may begin an online shopping experience by accessing various business merchants and shopping venues available via the graphical interface of the online banking account.

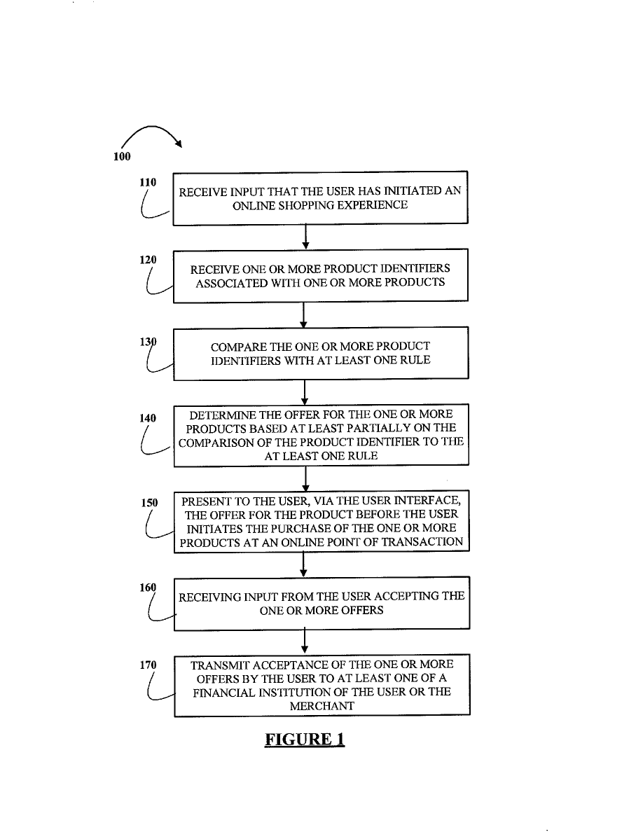

Referring now to FIG. 1, a general process flow 100 is provided for presenting an offer during a shopping experience, in accordance with an embodiment of the invention. As represented by the block 110, the system receives input that the user has entered a business-merchant store. In some embodiments, the system receives input that the user has entered the store from a mobile device associated with the user. In some embodiments, the system receives input that the user has entered the store by the user indicating, manually, by inputting using an interface associated with the mobile device, that she has entered the store or is about to enter the store. In another embodiment, the system automatically receives input that the user has entered the store when an application for presenting offers is accessed by the user or mobile device. In another embodiment, the system receives input that the user has entered the store when the phone, automatically and without any indication from the user, determines that the user has arrived at a business-merchant store. For example, in some such cases, the mobile device may include a positioning device that allows the mobile device to determine the position of the user associated with the mobile device. In some embodiments, the system receives input that the user has entered the business-merchant store when the user inputs information associated with an electronic loyalty card, store card, or store credit card associated with the business-merchant.

In another embodiment of the invention, where the user's shopping experience is out-of-store, the system is configured to provide a remote online user interface that is associated with a display device of a computerized apparatus that is configured to receive input that the user has initiated an out-of-store or remote online shopping experience. In some embodiments, the online user interface comprises a graphical user interface for an online banking system, but in other embodiments, the graphical user interface is for some other kind of system. In some embodiments, the graphical user interface comprises an Internet web page, an intranet web page, an online banking computer software application, and/or some other graphical user interface operatively connected to a system executing some or all of process flow 100. The computerized apparatus may comprise a personal computer system, a mobile phone, a mobile tablet device, a public kiosk, an automated teller machine (ATM), and/or some other device configured to display a graphical user interface. So, for example, one embodiment of a system having process flow 100 is configured to receive input from the user during an out-of-store shopping experience via a computerized apparatus configured to communicate an Internet web page to a personal computer system comprising software and hardware configured to display the web page. In some embodiments, for example, the system may receive input that the user has initiated an out-of-store shopping experience when the user accesses an application or website associated with a business merchant.

According to some embodiments, the input that a user has entered a store may be positioning data which may include global positioning data. Global positioning data may include any information collected from methods, systems, apparatus, computer programs, etc. involving locating a user's position relative to satellites, fixed locations, beacons, transmitters or the like. In some instances, global positioning data may be collected from a GPS device, such as a navigation system. Such a navigation system may be, but is not limited to, hardware and/or software that is part of a mobile phone, smartphone, PDA, automobile, watch etc. or a commercially available personal navigation system or the like. The amount, nature and type of the global positioning data that is collected may depend on the merchant's relationship with the customer and the amount of information that the customer has authorized the merchant or third-party provider to collect. For instances, in some embodiments the global positioning data will be snapshots of the user's location at different times. For example, a snapshot of the user's location will be collected each time the GPS software, navigation system or application is activated. In such embodiments, the global positioning data may only provide historical information regarding the customer's location (e.g. at 9:30 a.m. the customer activated the GPS software and was at location X). Such historical positioning data may be used to estimate the customer's current position, such as determining a range of distances the customer may have traveled in the intervening time. Alternatively, the global positioning data may be combined with other positioning data to locate the customer's current position. In other instances, the global positioning data may dynamically provide information regarding the customer's current location as the customer moves from location to location. In such instances, additional positioning data may not be necessary to project the route of the customer or can be used to confirm the customer is traveling along the suggested route.

The positioning data of the customer may include mobile device data. Mobile device data may include information regarding the current location of the customer's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the current location of a mobile phone may be dynamically determined from the cell phone signal and cell towers being accessed by the mobile phone. In other instances, a mobile device may include software or hardware to locate the position of the mobile device from GPS signals, wireless network locations, and the like. Furthermore, mobile device data may be the time and location of calls placed using the telephone functionality of a mobile device. By way of example, if a customer purchases a cup of coffee at a local coffee house, and thereby triggers an indication of a point-of-sale transaction, a merchant may be able to locate the customer if the customer logs onto a wireless network at the coffee house (for instance by locating the IP address associated with the wireless network). In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position.

The positioning data of the customer may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the customer's recent, present or future location through expressed data. For instance, a user may upload a blog post, comment on a connection's page, send a friend an electronic message etc. that identifies the customer's location (e.g. micro-blog entry “Just enjoyed lunch at a new restaurant on 5^{th} street . . . check it out.”). Moreover, many already-existing social networks provide users with the ability to “check-in”, “flag” or otherwise indicate the user's current location. Accordingly, customer positioning data collected from social networking data may consist of such indications. Furthermore, many social networks allow users to rate, like, comment etc. on restaurants, attractions, locations and the like. Accordingly, a customer may indicate that he ate at a certain restaurant or business at a given time and thereby provide information about his location at that time. Furthermore, a customer may upload photographs to a social networking site and thereby provide information about the customer's location. In some instances the customer's location may be determined from the picture, (for example a picture of a state line sign, a highway sign, a mile marker etc.) or a caption associated with the picture may indicate the customer's location and/or the time the photo was taken. As with the global positioning data, if the social network data only includes historical location data, the social network data may be used to estimate the customer's location or be combined with other positioning data to locate the customer.

In one embodiment, a processor associated with a mobile device associated with the user determines the location of the mobile device by connecting to a wireless network provided by the merchant. In some embodiments, a processor associated with a mobile device associated with the user determines the location of the mobile device by communicating with another device or network for which the location is known.

In one embodiment, prior to or contemporaneously with the shopping experience the user may set up a feed of information to the system that includes information about the user. The source of the information associated with the user may include one or more social networks, clubs, affinity groups, and/or the like that describe social and or business affiliations of the user and that may also describe various statuses and/or user-specific attributes of the user. For instance, one feed or source of information to the system may include a user's social networking web page that may indicate that the user is a former war veteran, visually-impaired, and is a part of a soccer club for his/her children. Based at least in part on the information from the user's social networking feed or web page, the system is configured to determine offers during the user's shopping experience, wherein the offers relate to the information associated with the user's social networking site. The system may offer, during the user's shopping experience, a special 10% discount that is specific to veterans when the user selects certain products for purchase.

In some embodiments, the system is configured to receive pre-selected coupons and determine offers during the user's shopping experience based at least in part on the pre-selected coupons. For example, prior to shopping or contemporaneously with a shopping experience go online to access virtual or online coupons. The user may select the online coupons and designate the selected online coupons for the user's current or upcoming shopping experience. In this way, the user may designate certain pre-selected coupons that she is interested in using during her shopping experience and the system may determine one or more available offers based at least in part on the user's pre-selected coupons.

As represented by the block 120, the system may also receive a product identifier. For example, in some embodiments, the system receives a product identifier from a data capture device associated with a mobile device associated with the user. In some embodiments, the data capture device may be a camera associated with the mobile phone, where the camera is configured to capture still pictures or motion video of product identifying information. In yet another embodiment, the data capture device may be a scanner or scanning device configured to capture coded information associated with a product (e.g. one dimensional bar code or a two dimensional bar code such as a quick response code (QR code)). In yet still another embodiment, the data capture device may be a device capable of capturing or reading information from a magnetic strip or other magnetic information device. The data capture device may also include one or more devices configured, and/or while using one or more visual recognition algorithms, to capture various forms of product identifiers, including any other visual tags, machine-readable patterns, computer-readable indicia, visual objects, and other data associated with a product. Computer-readable indicia as referred to herein may refer to any computer-readable color, image, pattern, scannable item (2D/3D), and/or the like.

In some embodiments of the invention, the system receives product identifying information through real-time object recognition analysis of product identifiers, such as but not limited to logos, artwork, products, locations, buildings, writing, barcodes, UPC, RF identification tags, people and other features that can be captured by a data capturing device. Capturing product identifiers may be done through a number of different data capture devices, as previously explained. Additionally, in one embodiment product identifiers may be captured utilizing a video stream (or image) and a system that matches product identifiers in the video (or image) to data associated with the products. Data associated with the products may include production information, pricing information, location information, quantity information, etc. about the same or similar products as the products captured by the data capturing device. In some embodiments, a product identifier is the product, itself.

In some embodiments of the invention, the system is configured to communicate the one or more products selected by the user online for purchase. In this way, the system aggregates the one or more products selected by the user during an online shopping experience and sends the information to the merchant's computer system or a computer system associated with a financial institution of the user. In one embodiment, the system also aggregates any offers determined during the user's online shopping experience and appends an aggregate of the one or more offers to the one or more products selected by the user. The system may communicate the offer to the merchant or financial institution in any way including via the internet or local network and in a form of a quick response (QR) code, e-mail, text or video message, and/or some other machine readable indicia. In this way, the merchant or financial institution can prepare the user's order for in-store pick and/or payment.

In certain embodiments of the invention, the system is configured to determine the location of the user within the store of the business merchant based at least partially on the received product identifier. In such embodiments, the system may determine the exact aisle location of the consumer within the store of the business merchant based on the received product identifier. In one embodiment, the system is configured to determine an offer for one or more different products located on the same or a proximate aisle for which the system determined that the consumer was located. For example, in one instance, the consumer is traveling through the shopping area of the store and selects or scans a box of cereal, and the system may then determine that the consumer is located in or near aisle one of the store. In such an instance, the system may present, to the consumer, an offer for a discount for oatmeal, which may also be located on aisle one of the store.

In some embodiments, the system is configured to review previous shopping history or transaction data of the consumer and based on the received product identifier, provide a recommendation to the consumer of one or more other products for purchase. In some embodiments, the shopping history of the consumer includes a record of the past one or more products purchased by the consumer, the locations of the purchases, the form of payments for the consumer's purchases, etc. In one embodiment, the system is configured to review the previous shopping history of the consumer and based at least in part on the received product identifier, provide a recommendation to the consumer of one or more other products for purchase together with any offers for the recommended items.

In one embodiment of the invention, the invention includes a mounting apparatus configured to be mounted to a cart for shopping and further configured to receive a user's mobile device. In one example, the mount device is already installed on the cart for shopping. In this way, the user may simply place a mobile device on the mount already installed on the shopping cart. In another example, the user is associated with a mount that the user may install onto the cart for shopping. In this way, the user may then place a mobile device on the mount the user installs prior to beginning a shopping experience at a merchant store. Once the user's mobile device is mounted, the mobile device can begin to capture, either within the mobile device's field of view or some wireless communication mechanism, the one or more products that the user has selected for purchase as the items are placed in the cart for shopping. The mobile device may capture the one or more products being placed in the cart using any of the one or more systems, devices, and/or methods described herein. After placing the items in the shopping cart, the user may be presented with offers for the one or more products, via a user interface associated with the mobile device of the user.

As represented by the block 130, the system may compare the product identifier to at least one rule. In some embodiments, the comparison may involve comparing information associated with the product identifier to the at least one rule, where the at least one rule relates at least partially to presenting the user with offers for loyalty points, coupons, discounts, and payment suggestions. In one embodiment, the system is configured to compare the product identifier to information associated with one or more offers and match the product identifier with the one or more offers for the product associated with the product identifier. In some embodiments, the system is configured to apply the one or more product identifiers to the at least one rule.

In one embodiment of the system, the at least one rule is at least partially related to offers for one or more products. In one embodiment of the system, the at least one rule is at least partially related to discounts for purchasing the product. For example, when the user scans or inputs a product identifier for a product, the system may determine that there is a $3 discount available for the product that is redeemable at checkout. In another embodiment of the system, the at least one rule is at least partially related to payment suggestions for the product associated with the product identifier. For example, the system may determine, using the at least one rule, that using a credit card associated with the user's profile may provide cash back rewards if used to purchase the product. In another embodiment, the at least one is at least partially related to coupons for the product associated with the product identifier. In some embodiments, the at least one rule is at least partially related to loyalty points for the product associated with the product identifier. The at least one rule may relate to various incentives to the user that may reduce the overall purchase price of the product associated with the product identifier and/or provide some incidental benefit that the consumer would otherwise not receive by merely purchasing the product without inputting a product identifier for the product. The system may determine an offer for a product based at least partially on user preferences for offers, user transaction data, user shopping history, and/or a user's profile. A user's profile may include demographic information about the user, financial information about the user including a list of credit or debit accounts available to the user, and/or the like.

In some embodiments, the at least one rule relates to determining which of a plurality of offers for one or more products to present. In such a case, the at least one rule relating to determining which of a plurality of offers to present determines the offers to present by comparing the plurality of offers and presenting the one or more offers having the highest potential benefit or dollar savings to the user. For example, if the user inputs a product identifier that when compared to the at least one rule triggers two or more offers, where a first offer is for a 20% discount on a product and a second offer is for $20 dollar reduction of the product price, the system is configured to determine, using the at least one rule, which of the first or second offer results in the highest benefit or dollar savings to the user. The system would subsequently present the offer with the highest dollar savings to the user. In such case, the system may be further configured to present an alternative offer button, such as a button with the text “Alternative Offer!”, so that the user has the option to select the other offer.

In one embodiment, the system is configured to send the product identifier to a merchant and receive from the merchant an offer for the product associated with the product identifier. In some embodiments, the system compares the product identifier to information associated with offers, loyalty points, coupons, discounts, and payment suggestions.

As used herein, the term “payment suggestion” refers to a recommendation by the system, method, or computer program product of a payment vehicle. A “payment vehicle” may be used by a user for paying a purchase amount. A payment vehicle may be any payment instrument such as a credit or debit account, credit/debit account, bank card, any negotiable instrument, virtual monies, or other instrument that can be used by one entity to pay another entity.

As represented by the block 140, the system determines a dynamic offer or an offer for a product associated with the product identifier based at least partially on the comparison of the product identifier to the at least one rule. For example, in some embodiments, once the system compares the product identifier to the at least one rule, the system determines that there is at least one offer and the type of offer for the product associated with the product identifier. In some embodiments, the system is configured to determine a dynamic offer based at least partially on two or more offers previously presented to the user. However, in other embodiments, the system may determine from some source other than the comparison that there is an offer for the product associated with the product identifier. In another embodiment, the system may be configured to determine an offer for the product associated with the product identifier only if the product associated with the product identifier matches product information for which the system has an associated offer stored in a database.

In some embodiments, the system is configured to review items inputted into the user's virtual or physical shopping cart and determine additional offers and/or suggestions for the items in the shopping cart. In such embodiments, the system may be configured to suggest an offer for hotdog buns when the user's shopping basket includes hotdogs. In another example, the system is configured to present an additional offer or new offer in lieu of a previous offer that may present a greater benefit to the user based on the one or more products in the user's shopping basket.

Once an offer for a product associated with the product identifier is determined, a system having the process flow 100 also presents to the user, via a user interface, the offer for the product before the consumer enters the point of transaction area of a business-merchant store or before checkout for an out-of-store shopping experience, as represented by the block 150. In some embodiments, the system presents an offer for the product during the consumer's shopping experience and while the consumer is still in the shopping area of the store of the merchant. In such embodiments, the offer is presented to the consumer while the consumer is in the shopping area of the store of the business merchant so that the consumer can make alternative or additional choices for products associated with the offers as the consumer travels through the store of the business merchant. In one embodiment, the system presents the offer for the product while the user is in a point of transaction area of a merchant store or during the checkout process. In some embodiments, the user interface is associated with the user's financial institution account (e.g., online banking account, mobile banking account, etc.) or a user interface associated with the user's social network account. The offer may be presented in a number of different forms and that the user interface may be secured or unsecured. For example, in one embodiment, the offer is presented as a path, such as a flashing link, that invites the user to follow the path to view and/or accept the offer. In another embodiment, the offer is presented as an advertisement for the product that directs the user to a website to view more information about the offer. In yet another embodiment, for example, the offer and information about the product are presented in the form of a pop-up (e.g., pop-up window, pop-up box, pop-up ad, etc.) that displays after information associated with a product identifier is captured or selected by the user. Other exemplary forms in which the offer may be presented in a graphical user interface include boxes, tabs, columns, windows, pages, buttons, links, fields, quotation bubbles, pop-ups, pop-unders, and/or the like.

In some embodiments, the system presents, via the user interface, the offer proximate to information associated with the product corresponding with the product identifier. For example, the system may present, via a user interface, an image of the product immediately next to the offer for the product. In another embodiment, the offer presented comprises an offer for the product proximate to information corresponding with the product. For example, the system may present, via the user interface, the offer in a pop-up box or separate window having an image and/or description of the product alongside the offer for the product.

In one embodiment, the system presents, via the user interface, two or more or a plurality of offers related to the product or item selected by the user. In this way, the system can present multiple offers to the user the same product and/or a related competing product. For example, a user may select 32 inch big screen TV for purchase. The system may determine that there are, at least, four offers for the 32 inch TV or for products related to and/or competing TVs. As such, the system is configured to present a plurality of offers related to the TV that may include for example, presenting (a) an offer to save 10% by applying for a store credit card, (b) an offer to save 12% when the user purchases the 32 inch TV and a premium mount, (3) an offer to save $300 when the user selects a 40 inch TV for purchase. In this way, all three offers are presented to the user at the same time proximate to each other so that the user can compare the offers. The system may also be configured to apply each offer associated with the products so that the user can visually compare the final prices of the products associated with each offer.

In yet another embodiment, the system is configured to present to the user the specifications of a product or ingredients of a product after the system receives the product identifier. For example, if the user scans a quick response (QR) code associated with a TV, the system is configured to present the specifications for the TV which may include the size of the TV screen, the type of display, the functionalities, and various features of the television.

It will be further understood that the offer may comprise any amount of information and display that information in a variety of different ways. In one embodiment, the offer may describe and/or quantify one or more benefits of the offer. In such an embodiment, for example, the offer may be for a store credit card that allows the user to save 15% on the product associated with the product identifier. Further, in such an embodiment, the offer may describe the dollar amount of savings on the product if the user accepts the offer. The offer may also include disclosure information associated with the store credit card offer, such as the proposed interest rate and any other legally required disclosure information. For example, the system will display an offer for the product where the offer comprises information describing that the user will save $30 when the product's price is $200. In one embodiment, the system is configured to apply the offers presented, as the products are processed and/or accepted by user and display, via the user interface, to the user the aggregate savings or aggregate benefits of all the offers for the one or more products in a user's physical or virtual shopping basket and/or cart. Similarly, in other examples, the system may present offers that describe the benefits various other offers including offers for loyalty points, coupons, payments suggestions, discounts, etc.

In yet another embodiment, the offer is a selectable path that comprises little information about the offer, such as a button with the text “Offer!” In such a case, the offer may be selected to display additional information about the offer within the user interface. The offer may also have a drop-down window that displays additional details about the offer if, for example, the user touches the portion of the user interface displaying the offer or drags a cursor over the offer.

It will be understood that, in some embodiments, the offer presented via a mobile device may also be accepted via the mobile device. For example, in one embodiment, an offer for a discount on a product associated with a product identifier is presented in the form of a path (e.g., a selectable link) via the mobile device, so that a user during a shopping experience in-store may follow the path to automatically redeem the offer. In another embodiment, an offer for a discount on a product associated with a product identifier is presented in the form of a path via a graphical user interface of a computerized apparatus, so that a user during an out-of-store or remote online shopping experience may follow the path to automatically redeem the offer. However, in other embodiments, the offer may not be configured to be accepted via the mobile device or graphical user interface of the computerized apparatus. In one embodiment, where the user's shopping experience is out-of-store, the offer can only be accepted or redeemed when the user goes to the physical business-merchant location associated with the business merchant's online website for an in-store pick up of the one or more selected products. In another example, in one embodiment, the offer merely directs the user to a particular website, area of a store, or phone that the customer must use to redeem the offer.

In some embodiments, the system is configured to provide a display, where the display provides to the user, during the shopping experience, a list or inventory of the products and associated offers for those products.

In one embodiment, the system is configured to provide a record or running tally of the one or more products selected for purchase by the consumer and/or the one or more offers accepted by the consumer. In some embodiments, the record or running tally are of the one or more products and/or the one or more offers accepted by the consumer that are within a virtual or physical shopping cart associated with the consumer. In some embodiments, the system is configured to display the record or running tally of the products and/or accepted offers to the user via a mobile computing device or personal computing device associated with the consumer. In certain embodiments, the system is configured to provide the record or running tally of the one or more products and/or the one or more offers accepted in real-time or near real-time. Near real-time is defined herein as the time required for data transaction and data processing to conduct the necessary functions needed to carry out the actions of providing a record or running tally of the one or more products and/or offers accepted by the consumer. In some embodiments, the system is also configured to provide a record or running tally of the sales tax associated with the one or more products selected for purchase along with the record or running tally of the products and/or offers accepted. In this way the consumer can readily determine the amount of total savings during the consumer's shopping experience. In certain embodiments, the system is configured to automatically update the record or running tally of the one or more products and one or more offers in the cart, as well as the sales tax after each product identifier is received.

In one embodiment, the system is configured to compare the user's online shopping cart, which includes the one or more products selected by the user during an online shopping experience for purchase to a hypothetical online shopping cart. In such an embodiment, the hypothetical online shopping cart is based at least partially on the contents of the user's online shopping cart, where the content of the hypothetical online shopping cart includes at least one alternative product for purchase. In some embodiments, the hypothetical online shopping cart also displays any offers associated with the online shopping cart and any amounts the user would save if she selected to purchase the one or more products in the hypothetical online shopping cart in lieu of purchasing the one or more products in her own online shopping cart.

It will also be understood that some embodiments may be configured to present offers to users during an online shopping experience via the user's online banking account. For example, an embodiment of the invention may be configured to present an offer to a user shopping online via an online banking account who has selected one or more products during an online shopping experience.

As represented by the block 160, the system may also receive an input from the user accepting the offer. In some embodiments, the system provides an opportunity for the customer to accept and/or redeem the one or more offers using the mobile device associated with the user. Accepting or redeeming the offer may include prompting the customer for input regarding accepting or redeeming an offer and then receiving the customer's input and communicating that input to the merchant or other interested party. In some embodiments, the system receives input for the user accepting the offer when the user simply purchases the one or more products having offers and/or using the payment vehicles associated with the payment suggestions present by the system. In some instances, the merchant then immediately reserves the offer for the customer either indefinitely or for a predetermined period of time. In some instances, the merchant requires a deposit or requires the customer to purchase the offer. Such mechanisms may lead to higher offer redemption because the customer has invested in the offer. Accepting or redeeming an offer, in some cases, may not require the customer to travel to the merchant's location, but rather, acceptance or redemption may occur remotely from the merchant location over a wireless connection with a computing or mobile device of the customer and/or over the Internet. In other instances, the customer may accept the offer while shopping in a merchant's store. In some embodiments, once the user has accepted/redeemed one or more offers, an electronic item is delivered to the user's mobile device in response to the acceptance/redemption. For example, in various embodiments, a user may accept, redeem, purchase or otherwise indicate desire to receive a product or service and that product is delivered, in some embodiments wirelessly, to the user's mobile device or virtual account. For example, the user may redeem an offer for an e-book that is delivered wirelessly to the user's mobile device, to the user's account, and/or to some other device owned by the user. In some instances, the user may redeem an offer for an e-coupon, an e-ticket or other e-good or e-service, where “e” refers to “electronic.”

In some embodiments, the system is configured to provide, via the user interface and to the user, a selectable button configured to apply all of the offers associated with the products in a user's virtual or physical shopping basket and/or cart, such as a button with the text “Apply All of My Offers!”. In one embodiment, the system is configured to provide, via the user interface, to the user a selectable button configured to provide a total price for all the products in a user's virtual or physical shopping basket and/or cart after the system has applied all offers.

In some embodiments, the offer presented to the user must be accepted or redeemed prior to a specific event. For example, in some embodiments, the offer presented to the user is set to expire, expires, or times-out upon completion of the user's shopping experience. In such cases, the end of a user's shopping experience may be indicated by the completion of an in-store checkout at a point of transaction, the completion of an online checkout, the user exiting the business merchant's store, the user logging off of an online banking session, the user logging out of an online shopping experience, a user leaving a business merchant's online website, by the user indicating that the shopping experience is complete using a mobile device or an online user interface, the user's mobile device determining that the shopping experience is complete, and/or the like. It will be understood that the end of a user's shopping experience may refer to any indication by the user or event that may indicate that a user's shopping experience has terminated.

As represented by the block 170, the system may also transmit acceptance of the offer by the user to at least one of a financial institution of the user or a business merchant associated with the product. In some embodiments, the system transmits the acceptance to the financial institution or business merchant using wireless and/or wireline communications. In some embodiments, the system transmits the acceptance of the offer using near field communication devices. In one embodiment, the system transmits the acceptance of the offer directly to the point of transaction system associated with the business merchant or financial institution. In some embodiments, the system transmits acceptance of the offer by a user via social media, email, text message (MMS or SMS), a telephone call, a voice message, or any other method of providing information via the user's electronic devices.

In some embodiments, the system is configured to provide verification that the user will receive all offers at a point of transaction or checkout. For example, the system is configured to display that the one or more offers are redeemed and applied to the transaction. In some embodiments, the system is configured to provide, at the point of transaction area, verification to the consumer that the one or more offers will successfully be applied to a transaction based at least partially on the one or more products being presented for purchase at the point of transaction area.

Additionally, it will be understood that the order of the events described in blocks 110-170 in FIG. 1 is exemplary and may vary. For example, a system executing some or all of the process flow 100 may receive a product identifier before, after, or substantially simultaneously with receiving input that a user has entered the store. It will also be understood that one or more of the events described in blocks 110-170 in FIG. 1 may occur in real-time or substantially real-time. For example, the system may be configured to determine in real-time, as the user is shopping and walking through a merchant store, an offer for a product associated with a product identifier received by the system. Further, one or more of the steps discussed with reference to FIG. 1 may be omitted or modified, and/or one or more steps in addition to those discussed with reference to FIG. 1 may also be executed by the system in conjunction with one or more of the steps discussed with reference to FIG. 1.

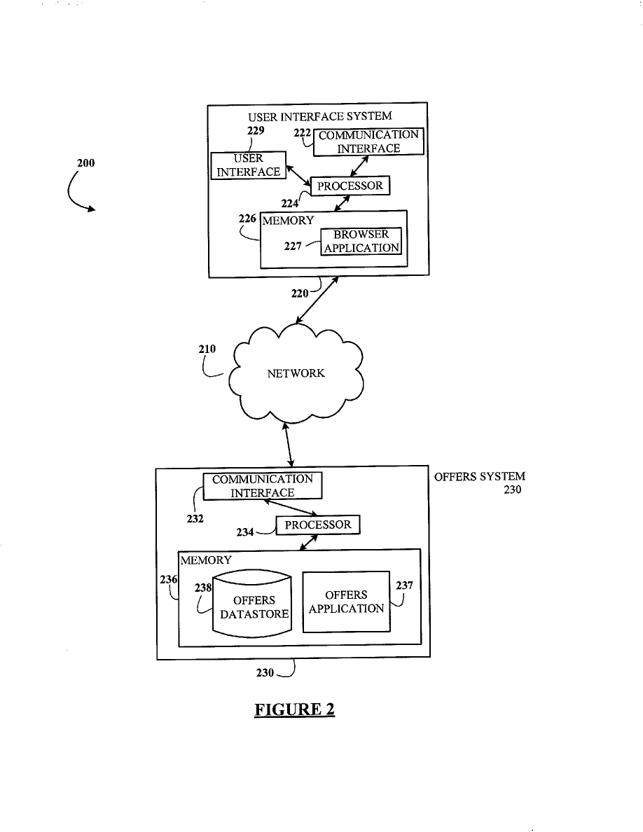

Referring now to FIG. 2, a system 200 is provided for presenting an offer during a shopping experience, in accordance with an embodiment of the invention. The system 200 includes a network 210, a user interface system 220, and an offers system 230. Each of the potions of the system 200 is operatively connected to the network 210 which may include one or more separate networks. Additionally, the network 210 may include a local area network (LAN), a wide area network (WAN), and/or a global area network (GAN), such as the Internet. It should be understood that the network 210 may be secure and/or unsecure and may also include wireless and/or wireline technology.

In one embodiment, the user interface system 220 is configured to allow a user (e.g., an in-store shopper or online shopper) to communicate with other networks and/or portions of the system 200, such as the offers system, and/or vice versa. For example, in one embodiment, the user interface system 220 is a computerized apparatus, such as a mobile phone, a personal computer system, or other mobile device, configured to receive input from the user and present offers via a graphical user interface. The user interface system 220 may also be configured to use a graphical user interface to view and/or accept one or more offers for a product associated with a received product identifier presented in the graphical user interface. In another embodiment, the user interface system 220 may be used to reject one or more of the offers via the graphical user interface.

In addition to the examples listed above, it will be understood that the user interface system 220 may include, for example, a portion of a computer network, a personal computer system, an Internet web browser, a mobile phone, a personal digital assistant, a public kiosk, a fax machine, and/or some other type of computerized apparatus. In one embodiment, as illustrated, the user interface system 220 includes a communication interface 222, a processor 224, a memory 226 having a browser application 227, and a user interface 229. The communication interface 222 is operatively connected to the processor 224, which is operatively connected to the user interface 229 and the memory 226 storing the browser application 227.

Each communication interface described herein, including the communication interface 222, includes hardware, and, in some instances, software, that enables a portion of the system 200, such as the user interface system 220, to transport, send, receive, and/or otherwise communicate information to and/or from the communication interface of one or more other portions of the system 200 or external to the system 200. For example, the communication interface 222 of the user interface system 220 may include a modem, server, and/or other electronic device that operatively couples the user interface system 220 to another electronic device.

Each processor described herein, including the processor 224, includes circuitry required for implementing the audio, visual, and/or logic functions of that portion of the system 200 including the processor. For example, the processor 224 of the user interface system 220 may include a digital signal processor device, a microprocessor device, and/or various analog-to-digital converters, digital-to-analog converters, and/or other support circuits. Control and signal processing functions of the user interface system 220 may be allocated between these devices according to their respective capabilities. The processor 224 may include functionality to operate one or more software programs based on computer-executable program code portions thereof, which may be stored, for example, in the browser application 227 of the memory 226 of the user interface system 220.

Each memory device described herein, including the memory 226 for storing the browser application 227 and other data, may include any computer-readable medium. For example, the memory 226 of the user interface system 220 may include volatile memory, such as volatile random access memory (RAM) including a cache area for the temporary storage of data. The memory 226 may also include other non-volatile memory, which can be embedded and/or may be removable. The non-volatile memory can additionally or alternatively include an EEPROM, flash memory, or the like. The memory 226 can store any one or more of pieces of information and data used by the user interface system 220 to implement the functions of the user interface system 220.

The browser application 227 may be any computer-executable program code portions configured to allow the user interface system 220 to communicate with other devices over a network using, for example, one or more network and/or system communication protocols. For example, in one embodiment, the browser application 227 includes an Internet Web browser used by the user interface system 220 for communicating with the various portions of the system 200.

The user interface 229 generally includes one or more user output devices, such as a display and/or speaker, for presenting information to a user. The user interface 229 further includes one or more user input devices, such as one or more keys or dials, a touch pad, touch screen, mouse, microphone, camera, scanner, and/or the like, for receiving information from the user.

Also illustrated in FIG. 2 is an offers system 230, in accordance with one embodiment of the invention. The offers system 230 may include, for example, a portion of a computer network, an engine, a platform, a network server, a database system, a front end system, a back end system, a personal computer system, and/or some other type of computing device. In one embodiment, as illustrated, the offers system 230 includes a communication interface 232, a processor 234, and a memory 236 having an offers application 237 and an offers datastore 238. The communication interface 232 is operatively connected to the processor 234, which is operatively connected to the memory 236 having the offers application 237 and the offers datastore 238.

In one embodiment, the offers application 237 includes computer-executable program code portions for instructing the processor 234 to present an offer for a product associated with a product identifier in the graphical user interface communicated to the user interface system 220. In another embodiment, the offers application 237 includes computer-executable program code portions for instructing the processor 234 to update the offers datastore 238 based on, for example, information provided by the consumer to the offers system 230 via the user interface system 220. In yet another embodiment, the offers application 237 includes computer-executable program code portions for instructing the processor 234 to compare a product identifier with the offers or at least one rule stored in the offers datastore 238.

In one embodiment, the offers datastore 238 is configured to store information associated with one or more products and/or one or more offers for those one or more products. For example, in one embodiment, the offers datastore 238 comprises information about every grocery item offered by a business merchant. In another embodiment, the offers datastore 238 comprises information about special, limited, and/or temporary offers, such as, for example, time sensitive discounts on products. In addition, it will be understood that, in at least one embodiment, the offers datastore 238 provides a substantially real-time representation of the information stored therein, so that when the processor 234 accesses the offers datastore 238, the information stored therein is current or substantially current.

The system 200 may implement any embodiment of the general process flow 100 described herein. Some or all of the portions of the system 200 may be combined into a single portion. Likewise, some or all of the portions of the system 200 may be separated into two or more distinct portions. In addition, the various portions of the system 200 may be maintained by the same or separate parties. For example, in one embodiment, a consumer maintains the user interface system 220 and a financial institution or a merchant maintains the offer system 230. In another embodiment, a financial institution maintains each and every portion of the system 200, including any embodiments of the network 210, user interface system 220, and offers system 230, as described herein.

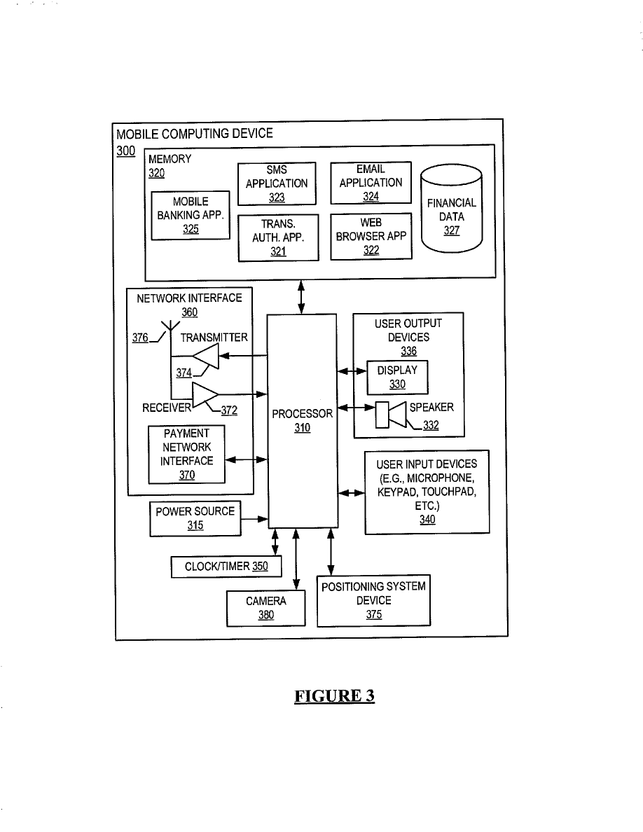

Referring now to FIG. 3, the mobile device 300 associated with the user is described. FIG. 3 provides a block diagram illustrating mobile computing device 300 in accordance with embodiments of the invention. In one embodiment of the invention, the mobile computing device 300 is a mobile telephone. However, it should be understood, however, that a mobile telephone is merely illustrative of one type of mobile computing device 300 that may benefit from, employ, or otherwise be involved with embodiments of the invention and, therefore, should not be taken to limit the scope of embodiments of the invention. Other types of mobile computing devices 300 may include portable digital assistants (PDAs), tablets, pagers, mobile televisions, gaming devices, laptop computers, cameras, video recorders, audio/video player, radio, GPS devices, or any combination of the aforementioned. The mobile computing device 300 may also be referred to herein as a “mobile device.”

The mobile computing device 300 generally includes a processor 310 communicably coupled to such devices as a memory 320, user output devices 336, user input devices 340, a network interface 360, a power source 315, a clock or other timer 350, a camera 380, and a positioning system device 375. The processor 310, and other processors described herein, generally includes circuitry for implementing communication and/or logic functions of the mobile computing device 300. For example, the processor 310 may include a digital signal processor device, a microprocessor device, and various analog to digital converters, digital to analog converters, and/or other support circuits. Control and signal processing functions of the mobile computing device 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile computing device 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 350. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. In some embodiments where network 350 is a wireless telephone network, the signals may include signaling information in accordance with the air interface standard of the applicable cellular system of the wireless telephone network. In this regard, the mobile computing device 300 may be configured to operate with one or more air interface standards, communication protocols, modulation types, and access types. By way of illustration, the mobile computing device 300 may be configured to operate in accordance with any of a number of first, second, third, and/or fourth-generation communication protocols and/or the like. For example, the mobile computing device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile computing device 300 may also be configured to operate in accordance with non-cellular communication mechanisms, such as via a wireless local area network (WLAN), near field communication network, or other communication/data networks.

The network interface 360 may also include a payment network interface 370. The payment network interface 370 may include software, such as encryption software, and hardware, such as a modem, for communicating information to and/or from one or more devices on a network 350. For example, the mobile computing device 300 may be configured so that it can be used as a credit or debit card by, for example, wirelessly communicating account numbers or other verification information to point of transaction computer system.

As described above, the mobile computing device 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the mobile computing device 300 to receive data from user, may include any of a number of devices allowing the mobile computing device 300 to receive data from a user, such as a keypad, keyboard, touch-screen, touchpad, microphone, mouse, joystick, other pointer device, button, soft key, and/or other input device(s). The user interface may also include a camera 380, such as a digital camera.

The mobile computing device 300 may also include a positioning system device 375 that is configured to be used by a positioning system to determine a location of the mobile computing device 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate location of the mobile computing device 300. In other embodiments, the positioning system device 375 includes a proximity sensor or transmitter, such as an RFID tag, that can sense or be sensed by devices known to be located proximate a merchant or other location to determine that the consumer mobile computing device 300 is located proximate these known devices.

The mobile computing device 300 further includes a power source 315, such as a battery, for powering various circuits and other devices that are used to operate the mobile computing device 300. Embodiments of the mobile computing device 300 may also include a clock or other timer configured to determine and, in some cases, communicate actual or relative time to the processor 310 or one or more other devices.

The mobile computing device 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile computing device 300 described herein. For example, the memory 320 may include such applications as a transaction authorization application 321, conventional web browser application 322, a SMS application 323, and email application 324 and/or mobile banking application 325. These applications also typically provide a graphical user interface (GUI) on the display 330 that allows user to communicate with a point of transaction computer system and/or financial institution computer system. In some embodiments, memory 320 may store financial data 327. Financial data 327 may comprise any data or information relating to transactions of a user, such as credit card information, debit card information, bank account information, and/or information necessary to validate transactions involving the user. In some embodiments, financial data 327 may include the stored information that is used to determine offers for products during a user shopping experience.

The memory 320 can also store any of a number of pieces of information, and data, used by the mobile computing device 300 and the applications and devices that make up the mobile computing device 300 or are in communication with the mobile computing device 300 to implement the functions of the mobile computing device 300 and/or the other systems described herein.

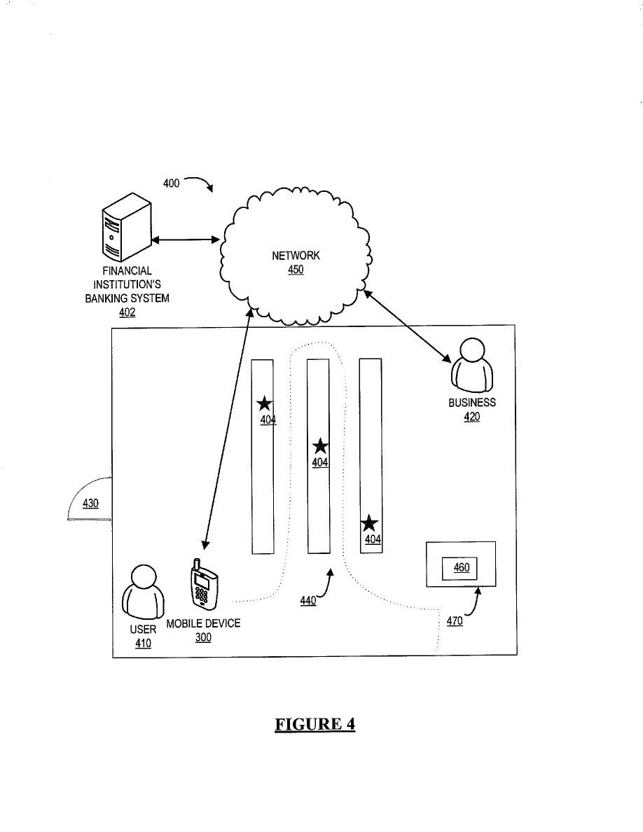

Referring to FIG. 4, a block diagram illustrating a layout of an environment 400 in which a user 410 shops for one or more products 404 in a facility or store of a business merchant 420, in accordance with an embodiment of the invention. In one embodiment, the environment is the store of a business merchant 420, where the store of the business merchant comprises, at least, an entrance area 430, a shopping area 440, and a point of transaction area 460. The “entrance area,” as used herein, refers to the place of entry or a means or point by which to enter the store of the business merchant. Hence, the entrance area 430 of the store is configured to allow access to a customer into the interior of the store of the business merchant 420. In some embodiments, there are multiple entrance areas to the store of the business merchant 420 but for simplicity, only one entrance area 430 is shown in FIG. 4. In some embodiments, an entrance area 430 comprises a portion of the shopping area 440 and/or point of transaction area 460 of the store, but for simplicity the entrance area 430 is shown distinct and separate from the shopping area 440 and point of transaction area 460 of the store of the business merchant 420. In one embodiment, the entrance area 430 comprises exterior signage and is configured to offer a view into the interior of the store of the business merchant.

The “shopping area,” as used herein, refers to one or more location within a retail store or store of a business merchant 420 where consumers can examine goods or services of the store of the business merchant 420 for purchase. In some embodiments, the shopping area comprises a portion of the entrance area 430 of the store and/or a portion of the POT area 460 of the store, but for simplicity the shopping area 440 is shown in FIG. 4 as a distinct and separate area from the entrance area 430 and POT area 460 of the store of the business merchant 420. In some embodiments, the shopping area 440 comprises a plurality of products 404 for purchase by a consumer. In another embodiment, the shopping area 440 comprises a plurality of aisles, where the aisles comprise shelves with a plurality of products 404 thereon.

The POT area 460, as previously described, is shown in FIG. 4. As shown in FIG. 4, the POT area 460 is located at the point-of-sale area 470 “POS area” of the store of the business merchant 420. The “POS area,” as used herein, refers to the point of purchase or check out location. In some embodiments, the POT area 460 comprises a portion of the entrance area 430 and/or shopping area 440 of the store of the business merchant 420, but for simplicity the POT area 460 is shown in FIG. 4 as a distinct and separate area from the entrance area 430 and shopping area 440 of the store of the business merchant 420.

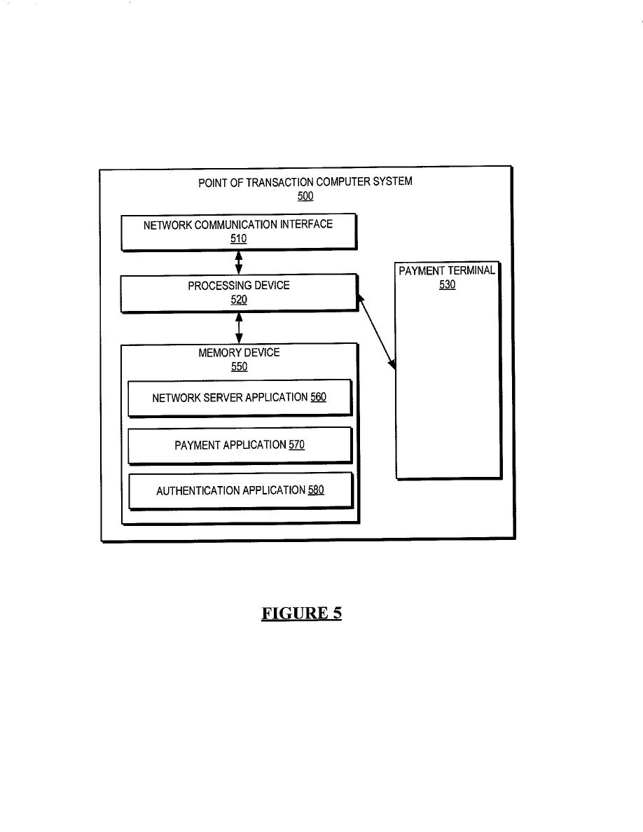

FIG. 5 provides a block diagram illustrating the point of transaction computer system 500, in accordance with an embodiment of the invention. As illustrated in FIG. 5, in one embodiment of the invention, the point of transaction computer system 500 includes a processing device 520 operatively coupled to a network communication interface 510 and a memory device 550. In certain embodiments, the point of transaction computer system 500 is operated by a merchant or other commercial entity that may enter into transactions with a user.

It should be understood that the memory device 550 may include one or more databases or other data structures/repositories. The memory device 550 also includes computer-executable program code that instructs the processing device 520 to operate the network communication interface 510 to perform certain communication functions of the point of transaction computer system 500 described herein. For example, in one embodiment of the point of transaction computer system 500, the memory device 550 includes, but is not limited to, a network server application 560, payment application 570 and a verification application 580. The computer-executable program code of the network server application 560, the payment application 570, or the verification application 580 may instruct the processing device 520 to perform certain logic, data-processing, and data-storing functions of the point of transaction computer system 500 described herein, as well as communication functions of the point of transaction computer system 500. In some embodiments, point of transaction computer system 500 may execute payment application 570 to initiate functionality configured to conduct a transaction, such as initiating the functionality that allows a near field communication payment terminal to conduct transactions with a user's mobile phone.

Additionally, as illustrated in FIG. 5, point of transaction computer system 500 also includes payment terminal 530 operatively coupled to processing device 520. In this embodiment of the invention, payment terminal 530 is a NFC payment terminal that allows mobile device 300 to conduct financial transactions using e-wallet functionality. In this embodiment of the invention, payment terminal 530 may be located external to the rest of transaction computer system 500. Although not depicted in FIG. 5, in some embodiments of the invention, payment terminal 530 may include a processor, memory device, and communication interface. In some embodiments of the invention, payment terminal 530 may communicate with mobile device 300 over the network independent of network communication interface 510 and in some of these embodiments, information received by payment terminal 530 may be transmitted by network communication interface 510.

Although many embodiments of the invention have been described above, the invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the invention described and/or contemplated herein may be included in any of the other embodiments of the invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed:

1. A system for presenting one or more offers to a consumer, during an out-of-store shopping experience online, before an in-store pick up or delivery of at least one of the one or more products selected by the consumer for purchase from a merchant, the system comprising:
a communication interface;
a database comprising at least one rule, where the at least one rule relates to offers for one or more products;
a computer apparatus associated with the consumer, where the computer apparatus comprises a user interface;
a processing device in communication with the communication interface, the database, and the computer apparatus;
a non-transitory computer-readable medium comprising computer-executable instruction code, that when executed causes the processing device to:
receive input that the consumer has initiated the online shopping experience;
receive one or more product identifiers associated with one or more products;
apply the one or more product identifiers to the at least one rule;
determine the one or more offers for the one or more products based at least partially on the application of the one or more product identifiers to the at least one rule;
present to the consumer, via the user interface, the one or more offers for the one or more products before the consumer initiates the purchase of the one or more products at an online point of transaction;
receive an input from the consumer accepting the one or more offers; and
transmit acceptance of the one or more offers by the consumer to at least one of a financial institution of the consumer or the merchant.

2. The system of claim 1, further comprising computer-executable instruction code, that when executed causes the processing device to:
provide, via the user interface, a selectable button comprising an invitation to the user to apply the one or more offers presented for the one or more products, wherein the selectable button is configured to apply the one or more offers to the one or more products when selected by the user.

3. The system of claim 1, further comprising computer-executable instruction code, that when executed causes the processing device to:
review a virtual or an online shopping cart comprising the one or more products selected by the consumer and make suggestions for one or more offers based on the one or more products in the virtual or the online shopping cart.

4. The system of claim 1, further comprising computer-executable instruction code, that when executed causes the processing device to:
display, via the user interface, the aggregate benefit provided by the one or more offers for the one or more products selected by the consumer, where the aggregate benefit comprises, at least, a total dollar savings amount or total points earned for purchasing the one or more products.

5. The system of claim 1, further comprising computer-executable instruction code, that when executed causes the processing device to:
determine a dynamic offer based at least partially on a combination of two or more offers previously presented to the user.

6. The system of claim 1, further comprising computer-executable instruction code, that when executed causes the processing device to:
provide, at the point of transaction, verification to the consumer that the one or more offers will successfully be applied to a transaction based at least partially on the one or more products being presented for purchase at the point of transaction.

7. The system of claim 1, wherein the at least one rule relates at least partially to presenting offers for discounts, coupons, loyalty points, or payment suggestions for the one or more products associated with the one or more product identifiers.

8. The system of claim 1, further computer-executable instruction code, that when executed causes the processing device to:
determine a first virtual or online shopping cart, wherein the first virtual or online shopping cart comprises the one or more products selected by the consumer;
determine a second virtual or online shopping cart based at least partially on the first virtual or online shopping cart, wherein the contents of the second virtual or online shopping cart is different from the first virtual or online shopping cart;
display, via the user interface, a comparison of the first virtual or online shopping cart to the second virtual or online shopping cart.

9. A computer program product for presenting one or more offers to a consumer, during an out-of-store shopping experience online, before an in-store pick up or delivery of at least one of the one or more products selected by the consumer for purchase from a merchant, the computer program product comprising:
a non-transitory computer readable medium comprising a set of codes for causing a computer to:
receive input that the consumer has initiated the online shopping experience;
receive one or more product identifiers;
apply the one or more product identifiers to at least one rule;
determine the one or more offers for one or more products associated with the one or more product identifiers based at least partially on the application of the one or more product identifiers to the at least one rule; and
present to the consumer, via a user interface of the computerized apparatus, the one or more offers for the one or more products before the consumer initiates the purchase of the one or more products at an online point of transaction;
receive an input from the consumer accepting the one or more offers; and
transmit acceptance of the one or more offers by the consumer to at least one of a financial institution of the consumer or the merchant.

10. The computer program product of claim 9, further comprising a set of codes for causing the computer to:
provide, via the user interface, a selectable button comprising an invitation to the user to apply the one or more offers presented for the one or more products, wherein the selectable button is configured to apply the one or more offers to the one or more products when selected by the user.

11. The computer program product of claim 9, further comprising a set of codes for causing the computer to:
review a virtual or an online shopping cart comprising the one or more products selected by the consumer and make suggestions for one or more offers based on the one or more products in the virtual or the online shopping cart.

12. The computer program product of claim 9, further comprising a set of codes for causing the computer to:
display, via the user interface, the aggregate benefit provided by the one or more offers for the one or more products selected by the consumer, where the aggregate benefit comprises, at least, a total dollar savings amount or total points earned for purchasing the one or more products.

13. The computer program product of claim 9, further comprising a set of codes for causing the computer to:
determine a dynamic offer based at least partially on a combination of two or more offers previously presented to the user.

14. A computer implemented method for presenting one or more offers to a consumer, during an out-of-store shopping experience online, before an in-store pick up or delivery of at least one of the one or more products selected by the consumer for purchase from a merchant, the computer implemented method comprising:
providing a computer processor executing computer readable code structured to cause the computer processor to:
receive input that the consumer has initiated the online shopping experience;
receive one or more product identifiers;
apply the one or more product identifier to at least one rule;
determine the one or more offer for one or more product associated with the one or more product identifiers based at least partially on the application of the one or more product identifiers to the at least one rule; and
present to the consumer, via a user interface of the computerized apparatus, the one or more offers for the one or more products before the consumer initiates the purchase of the one or more products at an online point of transaction;
receive an input from the consumer accepting the one or more offers; and
transmit acceptance of the one or more offers by the consumer to at least one of a financial institution of the consumer or the merchant.

15. The computer implemented method of claim 14, further comprising computer-executable instruction code, that when executed causes the processing device to:
provide, via the user interface, a selectable button comprising an invitation to the user to apply the one or more offers presented for the one or more products, wherein the selectable button is configured to apply the one or more offers to the one or more products when selected by the user.

16. The computer implemented method of claim 14, further comprising computer-executable instruction code, that when executed causes the processing device to:
review a virtual or an online shopping cart comprising the one or more products selected by the consumer and make suggestions for one or more offers based on the one or more products in the virtual or the online shopping cart.

17. The computer implemented method of claim 14, further comprising computer-executable instruction code, that when executed causes the processing device to:
display, via the user interface, the aggregate benefit provided by the one or more offers for the one or more products selected by the consumer, where the aggregate benefit comprises, at least, a total dollar savings amount or total points earned for purchasing the one or more products.

18. The computer implemented method of claim 14, further comprising computer-executable instruction code, that when executed causes the processing device to:
determine a dynamic offer based at least partially on a combination of two or more offers previously presented to the user.

19. The computer implemented method of claim 14, wherein the computer processor receives input that the user has entered the store from the computerized apparatus, automatically and independent of an indication by the user.

20. The computer implemented method of claim 14, further comprising computer-executable instruction code, that when executed causes the processing device to:
determine a first virtual or online shopping cart, wherein the first virtual or online shopping cart comprises the one or more products selected by the consumer;
determine a second virtual or online shopping cart based at least partially on the first virtual or online shopping cart, wherein the contents of the second virtual or online shopping cart is different from the first virtual or online shopping cart;
display, via the user interface, a comparison of the first virtual or online shopping cart to the second virtual or online shopping cart.
